(19) United States
(12) Patent Application Publication
(10) Pub. No.: US 2018/0122345 A1
(43) Pub. Date: May 3, 2018

(54) COMPACT SOUND STUDIO

(71) Applicants: Charles Bryant, Millville, NJ (US); Ollie Mae Maddox, Millville, NJ (US)

(72) Inventors: Charles Bryant, Millville, NJ (US); Ollie Mae Maddox, Millville, NJ (US)

(21) Appl. No.: 15/798,311

(22) Filed: Oct. 30, 2017

Related U.S. Application Data
(60) Provisional application No. 62/414,779, filed on Oct. 30, 2016.

(51) Int. Cl. G10H 1/00; G11B 20/10; G06F 3/16; H04S 3/00

(52) U.S. Cl. CPC G10H 1/0058; H04S 3/008; G06F 3/16; G11B 20/10527

(57) ABSTRACT

A compact, battery-powered, pocket-sized recording studio with headphones to offer consumers—in a device about the size of a smartphone—a means of recording, editing, mixing, and transferring their own vocal music, complete with backing instrumental and vocal tracks, special effects, harmonies, bass-lines, and drum-beats. Primarily appealing to aspiring musicians, the Compact Sound Studio would also be ideal for motivational speakers, priests and ministers, actors, and more.

### CROSS-REFERENCE TO RELATED APPLICATION

The present application is related to and claims priority from prior provisional application Ser. No. 62/414,779, filed Oct. 30, 2016 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of headset devices and more specifically relates to a compact, battery-powered, pocket-sized recording studio with headphones to offer consumers—in a device about the size of a smartphone—a means of recording, editing, mixing, and transferring their own vocal music or voice recording, complete with backing instrumental and vocal tracks, special effects, harmonies, bass-lines, and drum-beats.

### 2. Description of the Related Art

It might have begun on Ted Mack's “Amateur Hour,” back in the early days of television; or in the coffee-shop folk-music scene of the 1960's; or with the street-corner Doo-Wop groups of Philadelphia, the freelance urban break-dancers, deejays, and hip-hop artists of the 1970's; the Karaoke craze of the 1980s; the everyone-is-a-rapper tone of the 1990's; or in the current and continuing popularity of “American Idol”—who can say? But the plain fact is that Americans of all ages and persuasions love to make music and to hear themselves rhyme, rap, or sing. Maybe we all harbor a secret dream of finding fame and fortune before legions of adoring fans, or maybe we just enjoy the act of singing our soul's song in the car or the shower—but most of us, given the chance, love to sing. Ask the very worst singer on Karaoke night what it feels like to be up before the crowd holding that microphone, and—even if the crowd is blind-drunk and laughing uncontrollably—he or she will tell you, truthfully, that it's one of the greatest feelings a person can experience.

Saying we all like to sing, however, is a far cry from saying we all ought to, or have any future in doing so. But for those who sing or rap in search of a dream, who have some degree of talent and a lot of drive who yearn for a life in the glow of the footlights, expressing on stage the emotions of an audience in the darkened rows, there's a high and winding road to follow, with no certainty of success. As with any artistic pursuit, there's so much to learn and master—from a sure knowledge of the fundamentals of music to the myriad modes of a real stage-presence. One of the essential things to be learned, and learned early on, is getting comfortable with one's voice and the microphone. It's one thing to think you sound good singing with the stars on the radio, in other words, and quite another to sound good to others, solo and amplified.

Until now, an aspiring singer could acquire their chops in a couple of ways: working the small clubs night after night and hoping for that big eventual break, or finding the time and money—lots of money—to book time in a recording studio. Few hopefuls have the financial means to build their own studio, what with the space requirements, the masses of electronic gear, the soundproof room, the expense of hiring session-players—but what if an aspiring singer could create their own “studio” in which to practice, record, and edit their music, for about the price of a set of premium headphones?

Various attempts have been made to solve problems found in headset device art. Among these are found in: U.S. Pat. No. 7,262,358 to David L. Lubbers; U.S. Pat. No. 5,563,358 to Thomas G. Zimmerman; and U.S. Pat. No. 5,982,904 to Cullen et al. This prior art is representative of headset devices comprising a microphone and means for simulating a sound studio to enhance a user's singing performance None of the above inventions and patents, taken either singly or in combination, is seen to describe the invention as claimed.

Ideally, a compact sound studio should provide a portable lightweight means of recording, editing, mixing, and transferring their own vocal music, complete with backing instrumental and vocal tracks, special effects, harmonies, bass-lines, and drum-beats and, yet would operate reliably and be manufactured at a modest expense. Thus, a need exists for a reliable compact, battery-powered, pocket-sized recording studio to avoid the above-mentioned problems.

### BRIEF SUMMARY OF THE INVENTION

In view of the foregoing disadvantages inherent in the known portable sound studio art, the present invention provides a novel means of recording, editing, mixing, and transferring their own vocal music, complete with backing instrumental and vocal tracks, special effects, harmonies, bass-lines, and drum-beats. The general purpose of the present invention, which will be described subsequently in greater detail is to provide a device appealing to aspiring musicians, motivational speakers, priests and ministers and actors.

The present invention holds significant improvements in portability and ease of use. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, the Compact Sound Studio is constructed and operative according to the teachings of the present invention.

FIG. 1 shows a perspective view illustrating a Compact Sound Studio according to an embodiment of the present invention.

FIG. 2 is a perspective view illustrating the digital console of the Compact Sound Studio according to an embodiment of the present invention of FIG. 1.

FIG. 3 is a perspective view illustrating the CD player of the Compact Sound Studio according to an embodiment of the present invention of FIG. 1.

FIG. 4 is a perspective view illustrating a partial side view of the Compact Sound Studio according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a Compact Sound Studio and more particularly to a means of recording, editing, mixing, and transferring vocal music or the spoken word, complete with backing instrumental and vocal tracks, special effects, harmonies, bass-lines, and drum-beats. Primarily appealing to aspiring musicians, the Compact Sound Studio would also be ideal for motivational speakers, priests, ministers, and actors, and more as used to improve the portability and ease of use of a sound reproduction and enhancement device or system.

Generally Speaking the Compact Sound Studio comprises a specially designed unique, all-in-one, self-contained, compact and easily portable “pocket studio” for the recording, editing, transferring, and playing of audio content—from music to speeches to theatrical dialogue to sermons—all in a digital system about the size of a smartphone, and a very special set of headphones.

The Compact Sound Studio would include several components. First, is a set of adjustable, premium-quality padded headphones that may be used for listening to recorded content, as well as in the recording and editing process. The headphones feature a pivoting, sidebar microphone for singing or speaking in the recording process. The headphones are powered by an internal, rechargeable lithium-ion pill-type battery cell; and are also equipped with a standard cord and jack for use with a smartphone, an MP3 player, or the Compact Sound Studio digital console, as well as an interchangeable mini-USB cord that can be used with a personal desktop or laptop computer, or with the Compact Sound Studio console. The headphones feature a green/red power indicator and an On/Off button, and the phones may also be used to connect wirelessly with the Compact Sound Studio console for easy, hands-free recording and listening. The headphones will thus be the primary means of listening to content one has recorded with the Compact Sound Studio; and the headphone microphone will be the means of recording one's voice. The Compact Sound Studio console, however, is the master control module where content is recorded and stored, edited, manipulated, and organized—and the repository from which recorded content can be transferred to other devices, from personal computers to CD burners and MP3 players.

The control module is a compact unit, measuring perhaps 5 inches in width and length, and perhaps 1 inch in thickness or depth. This unit will be powered by an internal, rechargeable lithium-ion battery. A mini-USB charging cord will also be included. The control module would also function as a CD burner and player, recording audio content directly onto blank writable CDs. Further, a recording made, mixed, and completed on the Compact Sound Studio would be transferable to CD, MP3, or MP4, and thus easily shared. The control module is the device into which sound is recorded via the headphone microphone. The control module will be configured as a library, so that the user may select a wide variety of backing tracks, drum-beats, bass-lines, instrumental accompaniments and special audio effects—all of which the user will listen to, through the headphones, in the process of making their recordings. Just as a recorded song is built up, track-by-track, in a recording studio, the Compact Sound Studio would permit the user to build up multiple tracks in recording their own music.

The control module will be equipped with both standard and mini-USB jacks and cables so that the unit can be used with other sound-studio equipment, as well as allowing the user to expand the audio-effects library of the device by means of on-line musical resources. Thus, in addition to the standard Record/Play/Fast Forward/Rewind/Track/Track-Timer controls, the control module of the Compact Sound Studio will offer, through an easy-to-follow LCD touchscreen, all the backing tracks, bass lines, drum-beats, instrumental riffs and solos, backing vocals and other materials and ingredients that one would expect to find in a recording studio.

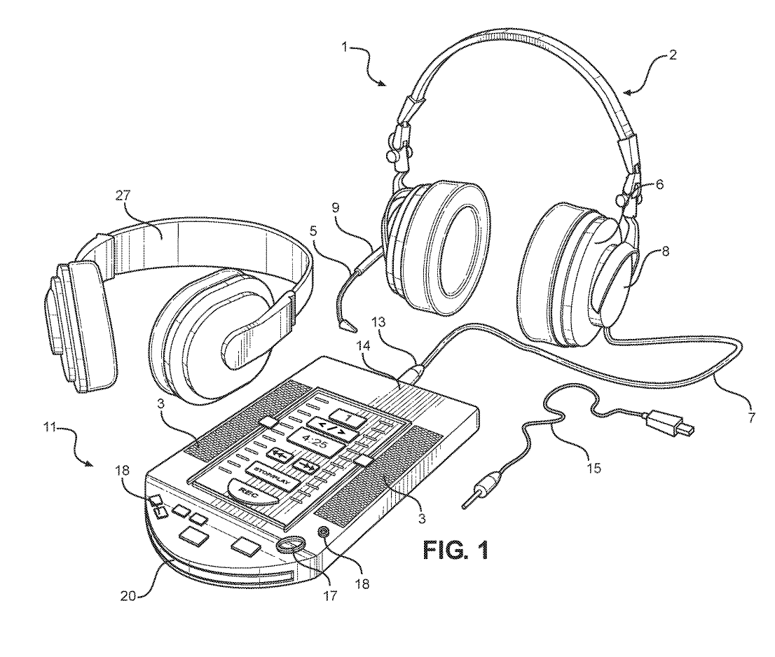

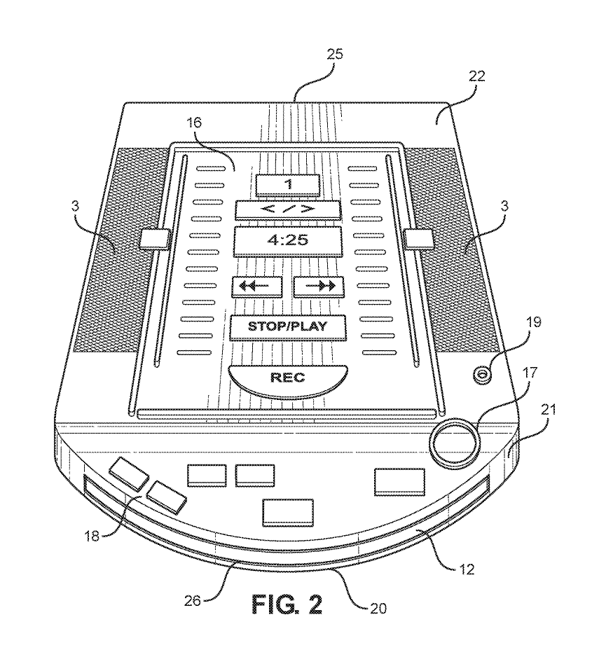

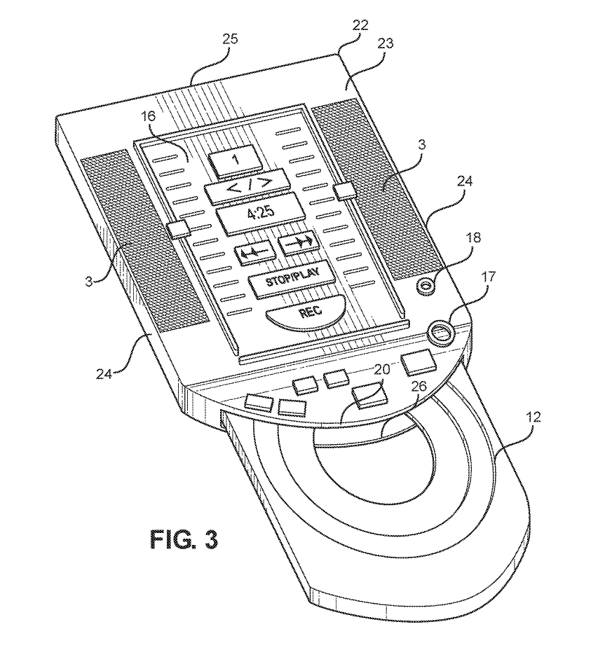

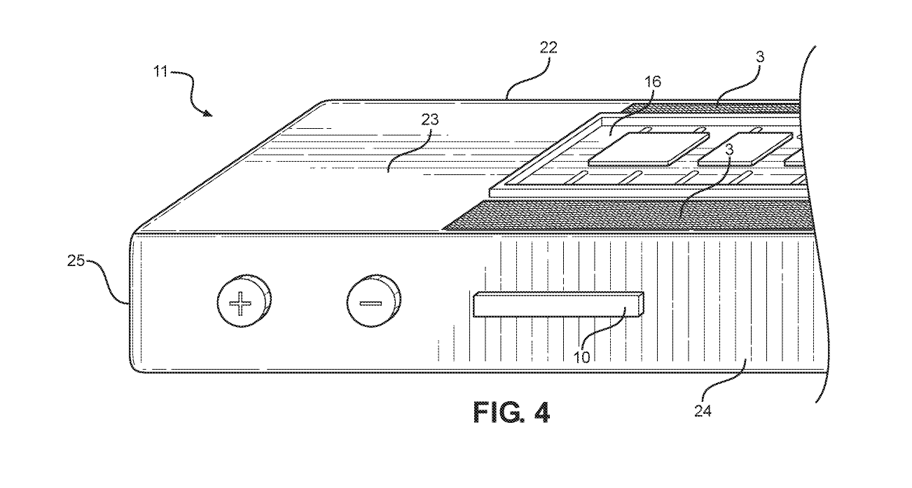

Referring to the drawings by numerals of reference there is shown in FIGS. 1-4, a compact sound studio 1 including a set of adjustable, premium-quality padded headphones 2 having internal speakers, a digital console 11 and a mini USB charging cord 15. The set of headphones 2 are used for listening to recorded content, as well as in the recording and editing process and are attached to the console 11 via a cord 7. The headphones 2 feature a pivoting, sidebar microphone 5 for receiving and transmitting audio input from a user including singing or speaking in the recording process. The headphones 2 are powered by an internal, rechargeable lithium-ion pill-type battery cell 6. The cord 7 has an output jack 13 for use with a smartphone, an MP3 player, or the digital console 11 for transmitting audio input. The digital console 11 is also configured for connection to an external power source for recharging the battery cell 6. A mini-USB charging cord 15 is provided for connection to a standard wall or car charging adaptor and can also be used with a personal desktop or laptop computer as well as the digital console 11 for charging the compact sound studio 1. The digital console 11 is also configured for wireless use and can be used with a set of wireless headphones 27 for easy listening and recording. The set of padded headphones 2 is also configured to wirelessly transmit said audio input.

The headphones 2 also feature a green/red power indicator 8 and an On/Off button 9. All headphone types are supported. The console 11 is also equipped with a pair of external speakers 3 which are coextensive with the first and second opposed side edges 24 of the housing 22.

The console 11 is the master control module where content is recorded, stored, edited manipulated, and organized—and the repository from which recorded content can be transferred to other devices, from personal computers to CD burners and MP3 or MP4 players. The digital console 11 is a compact unit, measuring perhaps five inches in width and length, and perhaps one inch in thickness or depth. The digital console 11 is comprised of a housing 22 having an upper surface 23 and first and second generally opposed side edges 24. The housing 22 also includes a rear surface 25.

The digital console 11 is also powered by an internal, rechargeable lithium-ion battery 17 and further has an input jack 14 on the rear surface 25 of the housing 22 for receipt of the output jack 13 of the headphone cord 7. The upper surface 23 of housing 22 also includes a pair of external speakers 3 each of which are coextensive with and delineated between the first and second generally opposed side edges 24 of the housing 22.

The console 11 also functions as a CD burner and player 12, recording audio content directly onto blank writable CDs with a CD storage time up to sixty minutes in length with unlimited track numbers. Further, a recording made, mixed, and completed is transferable to CD, MP3, or MP4, and thus easily shared. The CD burner and player 12 is located on a front surface 26 of the console 11 and has a semi-cylindrical edge 20 for accommodating the shape of a CD. The front surface 26 of the digital console 11 also has a USB port 21. One of the first or second generally opposed side edges 24 includes a micro SD slot 10 for receiving and transferring audio.

The console 11 is the device into which sound is recorded via the microphone 5. The console 11 has an internal master control module (not shown) and is configured as a library, so that the user may select a wide variety of backing tracks, drum-beats, bass-lines, instrumental accompaniments and special audio effects—all of which the user will listen to, through the headphones 2, in the process of making their recordings. Just as a recorded song is built up, track-by-track, in a recording studio, the present invention would permit the user to build up multiple tracks in recording their own music. The internal master control module is configured to record and store audio input whereby it can be edited, manipulated and organized such that it can be easily shared. The internal master control module is also configured for MP3 and MP4. The audio input is configured to be transferred to one of a CD, MP3, or MP4 so as to be easily shared.

The console 11 is equipped with both standard and mini-USB jacks and cables so that the unit can be used with other sound-studio equipment, as well as allowing the user to expand the audio-effects library of the device by means of on-line musical resources. Thus, in addition to the standard Record/Play/Fast Forward/Rewind/Track/Track-Timer controls, the console 11 of the present invention will offer, through an easy-to-follow LCD touchscreen 16, all the backing tracks, bass lines, drum-beats, instrumental riffs and solos, backing vocals and other materials and ingredients that one would expect to find in a recording studio.

The LCD touchscreen 16 is disposed between the pair of external speakers 3. The digital console 11 is configured with track and timer controls accessible through the LCD touchscreen 16 for editing and manipulating the audio input. The LCD touchscreen 16 is also configured to easily access the aforementioned backing tracks, bass lines, drum-beats, instrumental riffs, solos and backing vocals. The LCD touchscreen 16 is also configured to provide access to the aforementioned record, play, fast, rewind, stop and pause functions. The console 11 is also equipped with a Micro SD slot 10 on one of the opposed side edges 24 used to download, hold or transfer files.

Upon reading this specification, it should be appreciated that, under appropriate circumstances, considering such issues as design preference, user preferences, marketing preferences, cost, structural requirements, available materials, technological advances, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A compact sound studio comprising:
a set of padded headphones having;
a pivoting sidebar microphone for receiving an audio input from a user, a rechargeable battery cell for powering said microphone, a headphone cord having an output jack for transmitting said audio input,
a digital console comprised of;
a housing, said housing having an upper surface delineated by first and second generally opposed side edges, a rear surface, and a front surface, said upper surface comprises a pair of external speakers each of which are coextensive with said first and second side edges, said upper surface further comprises an LCD touchscreen disposed between said pair of external speakers, said rear surface having an input jack for receipt of said output jack of said headphone cord,
an internal master control module configured to record, and store said audio input whereby said audio input is edited, manipulated and organized such that it can be transferred.

2. The compact sound studio of claim 1 wherein, said front surface comprises a CD burner and player for recording and transferring said audio input to a writable CD, said front surface having a semi-cylindrical edge for accommodating said writable CD.

3. The compact sound studio of claim 2 wherein, said front surface further includes a USB port and wherein one of said first or second generally opposed side edges includes a micro SD slot for receiving and transferring audio.

4. The compact sound studio of claim 3 wherein, said LCD touchscreen is configured to provide access to one of record, play, fast, rewind, stop and pause functions.

5. The compact sound studio of claim 4 wherein, said LCD touchscreen is further configured to access one of backing tracks, bass lines, drum-beats, instrumental riffs, solos and backing vocals.

6. The compact sound studio of claim 5 wherein, said digital console is further configured with track and timer controls accessible through said LCD touchscreen for editing and manipulating said audio input.

7. The compact sound studio of claim 2 wherein, said digital console holds sixty minutes of CD digital material and an unlimited number of tracks.

8. The compact sound studio of claim 1 wherein, said set of padded headphones is configured to wirelessly transmit said audio input.

9. The compact sound studio of claim 2 wherein, said audio input is configured to be transferred to one of a CD, MP3, or MP4 so as to be easily shared.

10. The compact sound studio of claim 1 wherein, said digital console has a rechargeable battery.
